(19) United States
(12) Patent Application Publication
(10) Pub. No.: US 2007/0219718 A1
(43) Pub. Date: Sep. 20, 2007

(54) Method for presenting a navigation route

(75) Inventors: Scott M. Pennock, Lake Orion, MI (US); Rathinavelu Chengalvarayan, Naperville, IL (US)

Correspondence Address: GENERAL MOTORS CORPORATION;LEGAL STAFF, MAIL CODE 482-C23-B21, P O BOX 300, DETROIT, MI, 48265-3000, US

(73) Assignee: General Motors Corporation

(21) Appl. No.: 11/378,226

(22) Filed: Mar. 17, 2006

(51) Int. Cl. G01C 21/00

(52) U.S. Cl. 701/211; 701/200

(57) ABSTRACT

A method for presenting a navigation route to a user of a vehicle includes generating a navigation route. An audio prompt is played through a predetermined component of a vehicle audio system, where the predetermined component spatially corresponds to a direction of an upcoming maneuver of the navigation route.

### TECHNICAL FIELD

The present disclosure relates generally to navigation routes, and more particularly to a method for presenting a navigation route.

### BACKGROUND

Vehicle navigation systems are generally capable of generating vehicle navigation instructions, e.g. a route, from the vehicle's current position to a desired destination, as indicated by a user. After generating the route, the navigation system presents the route maneuvers to a user for execution. The navigation system often includes audio alerts (verbal and non-verbal) and alphanumeric and/or graphical displays for presenting the user with the generated route. The user may be prompted by the audio alerts informing the user of impending maneuvers. Further, the alphanumeric and/or graphical instructions may provide visual instructions and/or information regarding the maneuvers.

Due, at least in part, to the variety of distractions that may arise while driving, a user may miss and/or misinterpret an upcoming maneuver given by the audio prompt or visual display. Factors contributing to missing and/or misinterpreting an upcoming maneuver are the complexity or density of a road, street or freeway the user may be navigating. Another factor that may contribute to the confusion is the close proximity of multiple maneuvers, such as, for example, a complex freeway exit or entrance. Yet another factor potentially causing confusion may entail an upcoming maneuver that is substantially not visible to a user.

As such, it would be desirable to provide a system that is capable of improving the presentation of navigation route instructions for accurate execution of a navigation maneuver.

### SUMMARY

A method for presenting a navigation route to a user in a vehicle is disclosed herein. The method includes generating a navigation route, and playing an audio prompt through a predetermined component of a vehicle audio system. The predetermined component spatially corresponds to a direction of an upcoming maneuver of the navigation route.

### BRIEF DESCRIPTION OF THE DRAWINGS

Objects, features and advantages of embodiments of the present disclosure may become apparent by reference to the following detailed description and drawings, in which:

FIG. 1 is a schematic diagram depicting an embodiment of a navigation system;

FIG. 2 is a flow diagram depicting an embodiment of a method for transmitting a navigation route to a vehicle;

FIG. 3 is a cutaway perspective view of a user in a vehicle including an embodiment of an audio prompt playing through a predetermined component of the vehicle spatial audio system; and

FIG. 4 is a cutaway perspective view of a user in a vehicle including another embodiment of an audio prompt playing through a predetermined component of the vehicle spatial audio system.

### DETAILED DESCRIPTION OF THE EMBODIMENTS

Embodiment(s) of the system and method disclosed herein advantageously allow upcoming navigational route maneuvers to be delivered to the vehicle user from spatially corresponding components of the vehicle audio system. More specifically, the audio prompt communicates the upcoming maneuver to the user from a component of the audio system that is indicative of the direction of the upcoming maneuver. As such, the method advantageously provides substantially improved presentation of navigation routing instructions using spatial audio cues.

It is to be understood that, as defined herein, a user may include vehicle operators and/or passengers.

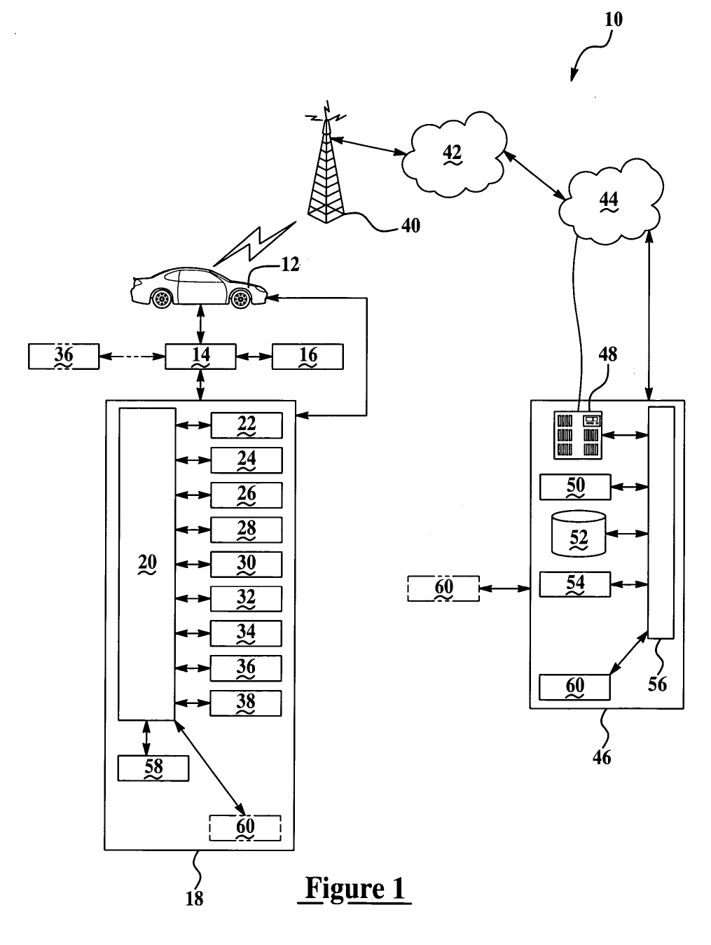

Referring now to FIG. 1, the system 10 includes a vehicle 12, a vehicle communications network 14, a telematics unit 18, a two-way radio frequency communication system (including, but not limited to, one or more wireless carrier systems 40, one or more communication networks 42, and/or one or more land networks 44), and one or more call centers/service providers 46. In one embodiment, vehicle 12 is a mobile vehicle with suitable hardware and software for transmitting and receiving voice and data communications. System 10 may include additional components suitable for use in telematics unit 18.

In an embodiment, via vehicle communications network 14, the vehicle 12 may send signals from the telematics unit 18 to various units of equipment and systems 16 within the vehicle 12 to perform various functions, such as unlocking a door, executing personal comfort settings, and/or the like. In facilitating interaction among the various communications and electronic modules, vehicle communications network 14 utilizes interfaces such as controller area network (CAN), ISO standard 11989 for high speed applications, ISO standard 11519 for lower speed applications, and Society of Automotive Engineers (SAE) standard J1850 for high speed and lower speed applications.

The telematics unit 18 may send and receive radio transmissions from wireless carrier system 40. In an embodiment, wireless carrier system 40 may be a cellular telephone system and/or any other suitable system for transmitting signals between the vehicle 12 and communications network 42. Further, the wireless carrier system 40 may include a cellular communication transceiver, a satellite communications transceiver, a wireless computer network transceiver (a non-limitative example of which includes a Wide Area Network (WAN) transceiver), and/or combinations thereof.

Telematics unit 18 may include a processor 20 operatively coupled to a wireless modem 22, a location detection system 24 (a non-limitative example of which is a global positioning system (GPS)), an in-vehicle memory 26, a microphone 28, one or more speakers 30, an embedded or in-vehicle mobile phone 32, a TTY unit 36, and/or a short-range wireless communication network 38 (e.g. a Bluetooth® unit).

It is to be understood that the telematics unit 18 may be implemented without one or more of the above listed components, such as, for example, speakers 30. Yet further, it is to be understood that the speaker 30 may be a component of the vehicle audio system, which may accept audio and/or other prompts/signals from the telematics unit 18. Telematics unit 18 may include additional components and functionality as desired for a particular end use.

Processor 20 may be a micro controller, a controller, a microprocessor, a host processor, and/or a vehicle communications processor. In another embodiment, processor 20 may be an application specific integrated circuit (ASIC). Alternatively, processor 20 may be a processor working in conjunction with a central processing unit (CPU) performing the function of a general-purpose processor.

Non-limitative examples of the location detection system 24 include a Global Position Satellite receiver, a radio triangulation system, a dead reckoning position system, and/or combinations thereof. In particular, a GPS provides latitude and longitude coordinates of the vehicle 12 responsive to a GPS broadcast signal received from a GPS satellite constellation (not shown).

The telematics unit 18 may also include an in-vehicle mobile phone 32, which may be a cellular type phone, such as, for example an analog, digital, dual-mode, dual-band, multi-mode and/or multi-band cellular phone.

Associated with processor 20 may be a real time clock (RTC) 34 providing accurate date and time information to the telematics unit hardware and software components that may require date and time information. In one embodiment, date and time information may be requested from the RTC 34 by other telematics unit components. In other embodiments, the RTC 34 may provide date and time information periodically, such as, for example, every ten milliseconds.

Processor 20 may execute various computer programs that interact with operational modes of electronic and mechanical systems within the vehicle 12. It is to be understood that processor 20 controls communication (e.g. call signals) between telematics unit 18, wireless carrier system 40, and call center 46. The processor 20 may have, but is not limited to having, monitoring, computational, decision-making, and communication capabilities.

Further, processor 20 may generate and accept digital signals transmitted between the telematics unit 18 and the vehicle communication network 14, which is connected to various electronic modules in the vehicle 12. In one embodiment, these digital signals activate the programming mode and operation modes within the electronic modules, as well as provide for data transfer between the electronic modules. In another embodiment, certain signals from processor 20 may be translated into vibrations and/or visual alarms.

It is to be understood that software 58 may be associated with processor 20 for monitoring and/or recording the incoming caller utterances.

The communications network 42 may include services from one or more mobile telephone switching offices and/or wireless networks. Communications network 42 connects wireless carrier system 40 to land network 44. Communications network 42 may be any suitable system or collection of systems for connecting the wireless carrier system 40 to the vehicle 12 and the land network 44.

The land network 44 connects the communications network 40 to the call center 46 (also referred to herein as a service provider). In one embodiment, land network 44 is a public switched telephone network (PSTN). In another embodiment, land network 44 is an Internet Protocol (IP) network. In still other embodiments, land network 44 is a wired network, an optical network, a fiber network, another wireless network, and/or any combinations thereof. The land network 44 may be connected to one or more landline telephones and/or mobile phones. It is to be understood that the communications network 42 and the land network 44 connect the wireless carrier system 40 to the call center 46.

Call center/service provider 46 may contain one or more data switches 48, one or more communication services managers 50, one or more communication services databases 52 containing subscriber profile records and/or subscriber information, one or more communication services advisors 54, and/or one or more network systems 56.

Switch 48 of call center 46 connects to land network 44. Switch 48 transmits voice or data transmissions from call center 46, and receives voice or data transmissions from telematics unit 18 in vehicle 12 through wireless carrier system 40, communications network 42, and land network 44. Switch 48 receives data transmissions from, or sends data transmissions to one or more of the communication service manager(s) 50, the communication services database(s) 52, and/or the communication services advisor(s) 54 via the network system(s) 56.

Call center 46 may contain one or more service advisors 54. In one embodiment, service advisor 54 may be human. In another embodiment, service advisor 54 may be an automaton.

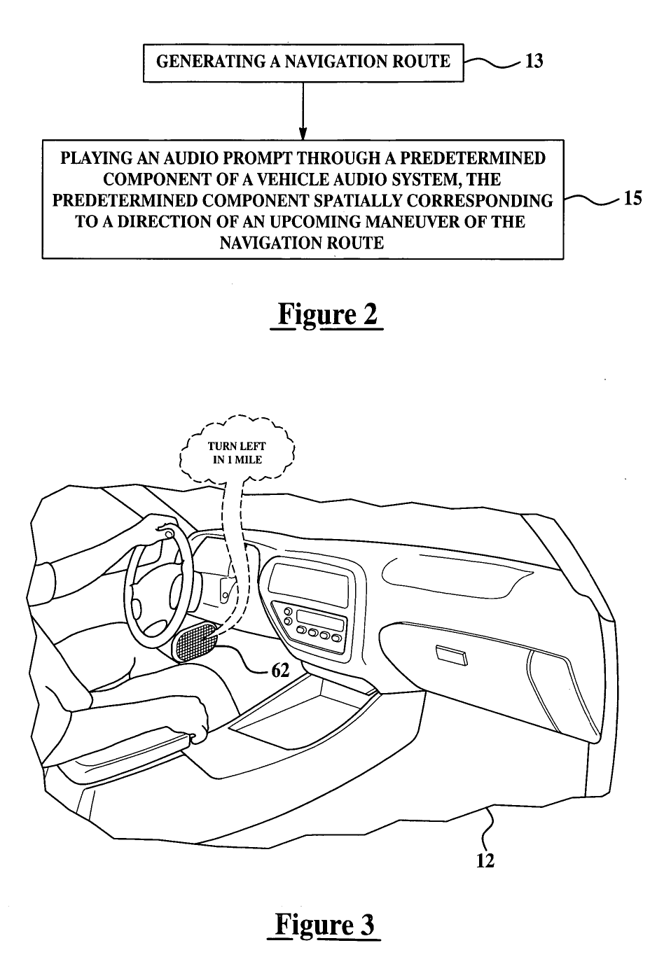

Referring now to FIG. 2, an embodiment of a method for transmitting a navigation route to a vehicle 12 includes generating a navigation route, as shown at reference numeral 13; and playing an audio prompt through a predetermined component of a vehicle audio system, the predetermined component spatially corresponding to a direction of an upcoming maneuver of the navigation route, as shown at reference numeral 15.

In an embodiment, a vehicle operator/user may initiate a call or a request for a navigation route via an input system. The input system is in communication with the two-way radio frequency communication system. Initiation of the request may be verbal and/or via a physical motion. As such, the input system may include an alphanumeric keypad, a microphone 28, a menu selection system, and/or combinations thereof.

Verbal communication may take place via microphone 28 coupled to the in-vehicle or mobile phone 32 associated with the telematics unit 18. Caller utterances into the microphone 28 are received at a call center 46, which tokenizes the utterance stream for further processing. In one embodiment, the tokenized utterances are placed in a subscriber information database 52 at the call center 46.

Physically initiating a navigation route request may be accomplished via a button press, touch screen, or the like located in the vehicle 12. It is to be understood that the button press or touch screen is operatively connected to the telematics unit 18. Upon the user's initiation of the button press or touch screen, the telematics unit 18 signals the call center 46 of the fact that the user has initiated a request.

A user may inform the call center 46 (either verbally or by using a TTY unit 36) of his/her desired destination. The TTY unit 36 may be useful in the present embodiment(s) if, for example, the person inputting the navigation route request is hearing-impaired, but the user/operator of the mobile unit 12 is not hearing-impaired. The user may also inform the call center 46 of his/her current position, or alternately, the call center 46 may locate the vehicle's current position via the GPS unit 24.

In an embodiment, the requested navigation route is generated at the call center 46 via an electronic route generator 60. It is to be understood that any other suitable route generator 60 may be used to produce the requested navigation route, including a route generator 60 located onboard the vehicle 12 or located external to the call center 46. The navigation route is generated in the form of audio prompts, which are transmitted to the vehicle 12 via the two-way communication system.

The audio prompts communicate the upcoming maneuvers of the navigation route to the vehicle user. The audio prompts are transmitted to predetermined components of the vehicle audio system. Each predetermined component of the vehicle audio system that emits an audio prompt spatially corresponds to a direction of the upcoming maneuver communicated by the particular audio prompt. For example, if a maneuver is on an incline and to the right, the audio prompt may appear to emanate from the upper right of the vehicle cabin, enabled by utilizing the predetermined components in combination. In another example, a verbal audio prompt may be followed by a non-verbal prompt spatially corresponding to the direction of, and distance to an upcoming maneuver. A non-verbal prompt may be, for example, a single tone, a series of tones, an audio object simulation (e.g., engine rpms), or the like. In still another example, the predetermined components of the vehicle audio system emit an audio prompt spatially corresponding to the direction of, and distance to an upcoming maneuver. Without being bound to any theory, it is believed that this may reduce the reaction time of a vehicle user and/or provide redundant route information, which may reduce the probability of a communication error.

The predetermined components of the vehicle audio system through which the audio prompts are played include, but are not limited to front speakers, rear speakers, right speakers, left speakers, front right speakers, front left speakers, rear right speakers, rear left speakers, rear door speakers, front door speakers, right door speakers, left door speakers, front right door speakers, front left door speakers, rear right door speakers, rear left door speakers, headliner speakers, and/or combinations thereof.

It is to be understood that any vehicle maneuver may be communicated as an audio prompt. Non-limitative examples of such maneuvers include turning, merging, exiting, reversing, continuing on a then-current path, parking, maneuvers on an incline, maneuvers on a decline, accelerating, decelerating, and/or combinations thereof.

The maneuvers of the generated navigation route may be transmitted to the predetermined components of the spatial audio system substantially sequentially. Generally, an audio prompt (indicative of an upcoming maneuver) is played at least once, and once the maneuver is performed, another audio prompt (indicative of the next upcoming maneuver) is played at least once. It is to be understood that the various audio prompts may be played through the same or different audio system components, depending, at least in part, on the direction of the upcoming maneuver that is communicated.

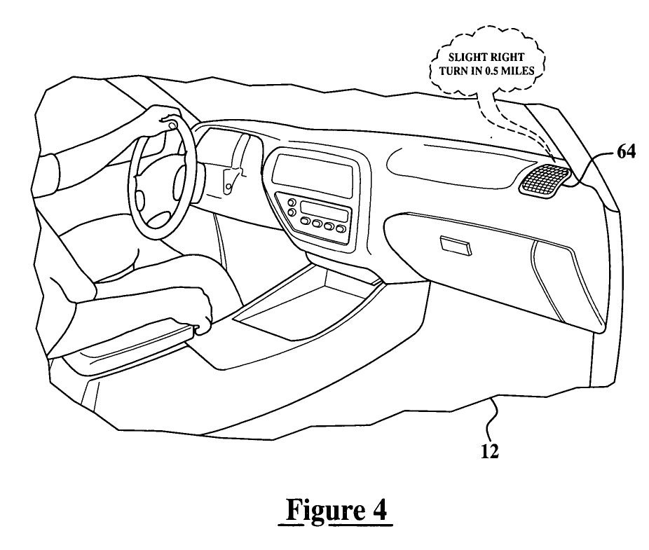

In a non-limitative example, the upcoming maneuver of the navigation route includes merging left, turning left, and/or turning slightly left. In this example, the spatially corresponding predetermined component of the vehicle audio system from which the audio prompt is played is selected from the left speakers, the front left speakers, the rear left speakers, the left door speakers, the front left door speakers, the rear left door speakers, and/or combinations thereof. An embodiment of this non-limitative example is shown in FIG. 3. The upcoming maneuver of the navigation route is a left turn in 1 mile, and the audio prompt is played through the front left door speaker 62.

In another non-limitative example, the upcoming maneuver of the navigation route includes merging right, turning right, and/or turning slightly right. In this example, the spatially corresponding predetermined component of the vehicle audio system is selected from the right speakers, the front right speakers, the rear right speakers, the right door speakers, the front right door speakers, the rear right door speakers, and/or combinations thereof. An embodiment of this non-limitative example is shown in FIG. 4. The upcoming maneuver of the navigation route is a slight right turn in 0.5 miles, and the audio prompt is played through the front right speaker 64.

In still another non-limitative example, the upcoming maneuver of the navigation route includes reversing the vehicle 12. In this example, the spatially corresponding predetermined component of the vehicle audio system from which the audio prompt is played is selected from the rear speakers, the rear right speakers, the rear left speakers, the rear door speakers, the rear right door speakers, the rear left door speakers, headliner speakers, and/or combinations thereof.

In any of the embodiments disclosed herein, as the audio prompt is played, the method may further include controlling gain, delay, filtering, and/or selection of a predetermined surround-sound channel; and/or controlling the vehicle's audio balance and/or fade.

While several embodiments have been described in detail, it will be apparent to those skilled in the art that the disclosed embodiments may be modified. Therefore, the foregoing description is to be considered exemplary rather than limiting.

1. A method for presenting a navigation route to a user in a vehicle, comprising:
generating a navigation route; and
playing an audio prompt through a predetermined component of a vehicle audio system, the predetermined component spatially corresponding to a direction of an upcoming maneuver of the navigation route.

2. The method as defined in claim 1 wherein, as the audio prompt is played, the method further comprises at least one of: controlling at least one of gain, delay, filtering, or selection of a predetermined surround-sound channel; or controlling at least one of the vehicle's audio balance or fade.

3. The method as defined in claim 1 wherein the predetermined component of the vehicle audio system is selected from front speakers, rear speakers, right speakers, left speakers, front right speakers, front left speakers, rear right speakers, rear left speakers, rear door speakers, front door speakers, right door speakers, left door speakers, front right door speakers, front left door speakers, rear right door speakers, rear left door speakers, headliner speakers, and combinations thereof.

4. The method as defined in claim 1 wherein the audio prompt communicates the upcoming maneuver to the user.

5. The method as defined in claim 1 wherein the upcoming maneuver is selected from turning, merging, exiting, reversing, continuing on a current path, parking, maneuvers on an incline, maneuvers on a decline, accelerating, decelerating, and combinations thereof.

6. The method as defined in claim 1 wherein the upcoming maneuver is selected from merging left, turning left, and turning slightly left, and wherein the predetermined component of the vehicle audio system is selected from left speakers, front left speakers, rear left speakers, left door speakers, front left door speakers, rear left door speakers, and combinations thereof.

7. The method as defined in claim 1 wherein the upcoming maneuver involves reversing the vehicle, and wherein the predetermined component of the vehicle audio system is selected from rear speakers, rear right speakers, rear left speakers, rear door speakers, rear right door speakers, rear left door speakers, headliner speakers, and combinations thereof.

8. The method as defined in claim 1 wherein the upcoming maneuver is selected from merging right, turning right, and turning slightly right, and wherein the predetermined component of the vehicle audio system is selected from right speakers, front right speakers, rear right speakers, right door speakers, front right door speakers, rear right door speakers, and combinations thereof.

9. The method as defined in claim 1, further comprising playing an other audio prompt through a predetermined component of a vehicle audio system, the predetermined component spatially corresponding to a direction of an other upcoming maneuver of the navigation route.

10. The method as defined in claim 1 wherein generating the navigation route includes:
initiating a navigation route request from the user; and
communicating the navigation route request from the user to a navigation route generator.

11. The method as defined in claim 10 wherein the user initiates the navigation route request via at least one of verbal communications and physical communications.

12. The method as defined in claim 10 wherein communicating the navigation route request is accomplished by transmitting the navigation route request to at least one of a call center, a telematics unit, or combinations thereof.

13. A system for presenting a navigation route to a user in a vehicle, comprising:
means for generating a navigation route; and
means for playing an audio prompt through a predetermined component of a vehicle audio system, the predetermined component spatially corresponding to a direction of an upcoming maneuver of the navigation route.

14. A method for presenting a navigation route to a user in a vehicle, comprising:
initiating a navigation route request from the user;
generating a navigation route; and
playing an audio prompt through a predetermined component of a vehicle audio system, the predetermined component spatially corresponding to a direction of an upcoming maneuver of the navigation route.

15. The method as defined in claim 14 wherein, as the audio prompt is played, the method further comprises at least one of: controlling at least one of gain, delay, filtering, or selection of a predetermined surround-sound channel; or controlling at least one of the vehicle's audio balance or fade.

16. The method as defined in claim 14, further comprising playing an other audio prompt through a predetermined component of a vehicle audio system, the predetermined component spatially corresponding to a direction of an other upcoming maneuver of the navigation route.

17. The method as defined in claim 14 wherein the audio prompt communicates the upcoming maneuver to the user.

18. The method as defined in claim 14 wherein the upcoming maneuver is selected from turning, merging, exiting, reversing, continuing on a current path, parking, maneuvers on an incline, maneuvers on a decline, accelerating, decelerating, and combinations thereof.

19. The method as defined in claim 14 wherein the upcoming maneuver is selected from merging left, turning left, and turning slightly left, and wherein the predetermined component of the vehicle audio system is selected from left speakers, front left speakers, rear left speakers, left door speakers, front left door speakers, rear left door speakers, and combinations thereof.

20. The method as defined in claim 14 wherein the upcoming maneuver involves reversing the vehicle, and wherein the predetermined component of the vehicle audio system is selected from rear speakers, rear right speakers, rear left speakers, rear door speakers, rear right door speakers, rear left door speakers, headliner speakers, and combinations thereof.

21. The method as defined in claim 14 wherein the upcoming maneuver is selected from merging right, turning right, and turning slightly right, and wherein the predetermined component of the vehicle audio system is selected from right speakers, front right speakers, rear right speakers, right door speakers, front right door speakers, rear right door speakers, and combinations thereof.
